(19) United States
(12) Patent Application Publication
(10) Pub. No.: US 2005/0108935 A1
(43) Pub. Date: May 26, 2005

(54) Method and system of manufacturing artificial seed coats

(76) Inventor: Edwin Hirahara, Federal Way, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/981,439

(22) Filed: Nov. 3, 2004

Related U.S. Application Data
(60) Provisional application No. 60/525,434, filed on Nov. 25, 2003.

(51) Int. Cl. A01C 1/06

(52) U.S. Cl. 47/57.6; 47/1.01 R

(57) ABSTRACT

A method of manufacturing an artificial seed blank (20) is provided. The method includes placing a seed shell (22) on one of a plurality of receptacles (72) at the first assembly station. The method also includes depositing media (26) into the seed shell and positioning the seed shell at a second assembly station. The method also includes removing the seed blank from the receptacle at the second assembly station.

### CROSS REFERENCE TO RELATED APPLICATION

The present application claims the benefit of U.S. Provisional Application No. 60/525,434, filed Nov. 25, 2003.

### FIELD OF THE INVENTION

The present invention relates generally to artificial seeds and, more particularly, to a method and system of manufacturing seed blanks for manufactured seeds.

### BACKGROUND OF THE INVENTION

Asexual propagation for plants has been shown for some species to yield large numbers of genetically identical embryos, each having the capacity to develop into a normal plant. Such embryos must usually be further cultured under laboratory conditions until they reach an autotrophic “seedling” state characterized by an ability to produce their own food via photosynthesis, resist desiccation, produce roots able to penetrate soil, and fend off soil microorganisms. Some researchers have experimented with the production of artificial seeds, known as manufactured seeds, in which individual plant somatic or zygotic embryos are encapsulated in a seed coat. Examples of such manufactured seeds are disclosed in U.S. Pat. No. 5,701,699, issued to Carlson et al., the disclosure of which is hereby expressly incorporated by reference.

Typical manufactured seeds include a seed shell, synthetic gametophyte and a plant embryo. A manufactured seed that does not include the plant embryo is known in the art as a “seed blank.” The seed blank typically is a cylindrical capsule having a closed end and an open end. The synthetic gametophyte is placed within the seed shell to substantially fill the interior of the seed shell. A longitudinally extending hard porous insert, commonly known as a cotyledon restraint, may be centrally located within the synthetic gametophyte and includes a centrally located cavity extending partially through the length of the cotyledon restraint. The cavity is sized to receive the plant embryo therein. The well-known plant embryo includes a radicle end and a cotyledon end. The plant embryo is deposited within the cavity of the cotyledon restraint cotyledon end first and is sealed within the seed blank by at least one end seal. There is a weakened spot in the end seal to allow the radicle end of the embryo to penetrate the end seal.

Currently, the seed shell is manufactured by hand and is formed from sectioning a tube, such as a straw, and processing the sections of the tube to enhance its abilities to withstand exposure to the environment. One such seed shell is manufactured by sectioning a straw of fibrous material, and then coating the resulting straw section with a wax. One suitable method for applying the wax coating is to dip the straw sections into a bath of wax. The straw sections are then withdrawn from the wax bath and then the wax is permitted to harden to seal the straw sections.

Although such seed blanks are effective, they are not without their problems. As a non-limiting example, because the current process of manufacturing seed blanks is manual, it is labor-intensive and, therefore, expensive. Additionally, because such existing processes are manual, manipulation and manufacture of a large number of seed blanks in accordance with existing practice can be time-intensive. As a result, mass production of manufactured seeds is not only time-consuming, but also expensive.

Thus, there exists a need for a method and system of manufacturing artificial seed blanks that can manipulate and assemble a large number of seed blanks at a relatively low cost, with a high degree of reliability, and without adversely affecting the quality of resulting seed blanks.

### SUMMARY OF THE INVENTION

In a material handling system having means for automatically assembling and transporting an artificial seed blank between a plurality of assembly stations arranged in a sequential configuration, a method of manufacturing an artificial seed blank is provided. The method includes placing a seed shell on one of a plurality of receptacles at a first assembly station, and depositing media into the seed shell. The method also includes positioning the seed shell at a second assembly station, and removing the seed shell from the receptacle at the second assembly station.

In accordance with another embodiment of the present invention, the method further includes heating at least one of the plurality of receptacles before placing a seed shell on one of the plurality of receptacles. Another embodiment also includes depositing a restraint on one of the plurality of receptacles before placing a seed shell on one of the plurality of receptacles. In still yet another embodiment, the method includes positioning the seed shell at a cooling station after depositing media into the seed shell to accelerate a state change of the media.

A material handling system for automatically assembling and transporting an artificial seed blank between a plurality of assembly stations arranged in a sequential configuration is also provided. The material handling system includes a transport assembly having a plurality of receptacles, each one of the plurality of receptacles is adapted to receive an artificial seed shell. A drive assembly is coupled to the transport assembly to selectively transport at least one of the plurality of receptacles between the plurality of assembly stations. The material handling system also includes a cooling assembly in communication with a portion of the transport assembly to accelerate a change in state of media disposed within the seed shell.

In yet another embodiment of the present invention, the material handling system includes a heater in communication with at least one of the plurality of receptacles, wherein the heater is adapted to preheat the receptacle. Further, a seed shell handling system is also suitably part of another embodiment of the present invention. The seed shell handling assembly is adapted to place a seed shell on one of the plurality of receptacles.

The method and system of manufacturing artificial seed blanks, as well as the resulting manufactured seed blank, formed in accordance with the various embodiments of the present invention, have several advantages over currently available methods. The method and system of the present disclosure is simpler to operate as it consolidates various parts of the assembly procedure at substantially one location. Also, because such a method and system is automated, it reduces manual labor required to manipulate and assemble seed blanks and, therefore, is cheaper than existing systems.

Thus, a method and system of manufacturing artificial seed blanks in accordance with the various embodiments of the present invention has a high degree of reliability, and is capable of mass producing artificial seed blanks at a relatively low cost.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a cross-sectional side view of a manufactured seed blank formed in accordance with various embodiments of the present invention;

FIG. 2 is an isometric view of one embodiment of a material handling system for automatically assembling and transporting an artificial seed blanks between a plurality of assembly stations; and

FIG. 3 is a partial isometric view of a portion of the material handling system of FIG. 2.

### DETAILED DESCRIPTION OF THE PREFERRED EMBODIMENT

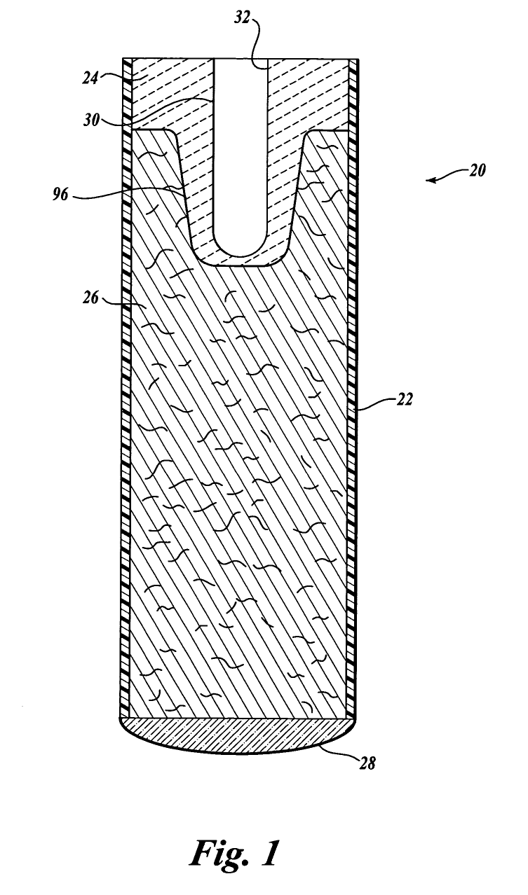

FIG. 1 illustrates a seed blank 20 constructed in accordance with certain embodiments of the present invention. Such a seed blank 20 is suitably used for a manufactured seed, such as is disclosed in U.S. Pat. No. 5,701,699, issued to Carlson et al., the disclosure of which is hereby expressly incorporated by reference.

The seed blank 20 includes a seed shell 22, a cotyledon restraint 24 and an end seal 28. The end seal 28 is shown for illustrative purposes only and is not a necessary element of the present invention.

The seed shell 22 is suitably formed from a tube. In one embodiment, the tube is a straw of fibrous material, such as paper, and is sectioned in appropriate lengths. The sections of straw are pretreated in a suitable coating material, such as wax. As another non-limiting example, the tubes are formed from a biodegradable plastic material. One such tube is sold by Biocorp North America of Los Angeles, Calif. Such biodegradable plastic tubes are similarly sectioned into appropriate lengths for use as a manufactured seed. Further, such biodegradable plastic tubes do not require a wax coating as such tubes are already resistive to environmental elements. It should be apparent that although sectioning tube is preferred, other embodiments, such as obtaining tubes of appropriate size for use as manufactured seeds, are also within the scope of the present invention.

The cotyledon restraint 24 is suitably manufactured from a hard, porous material and includes a stem 96 and longitudinally extending cavity 30. The open end of the cavity 30 is known as a cotyledon restraint opening 32. The cavity 30 is sized to receive a plant embryo (not shown) therein. The seed blank 20 also includes synthetic gametophyte 26 disposed within the seed shell 22, as is described in greater detail below.

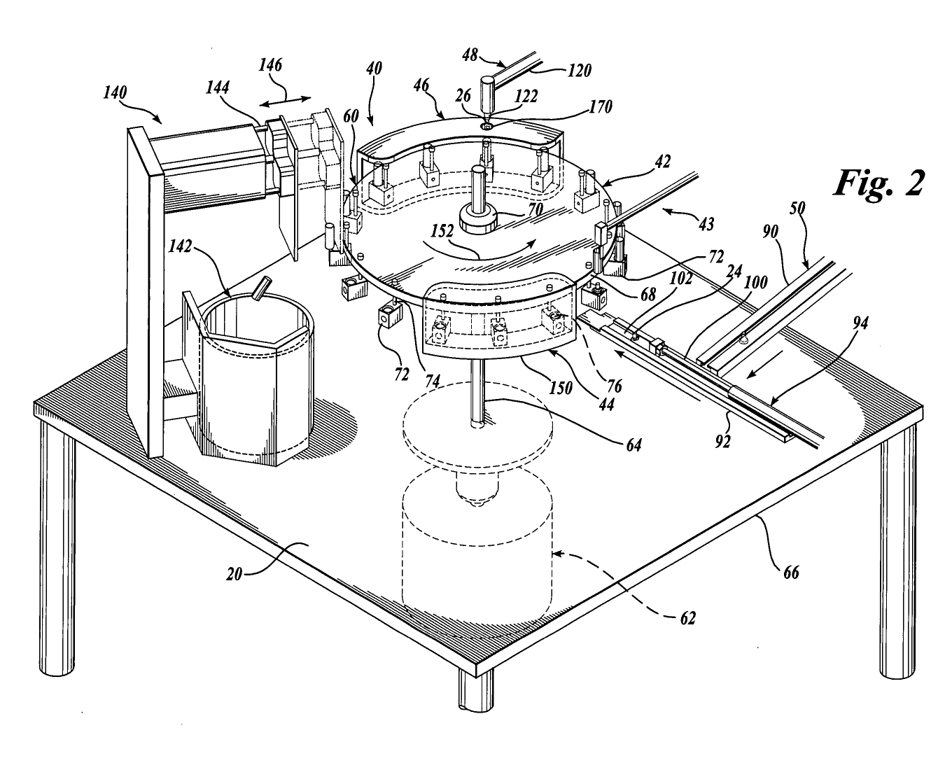

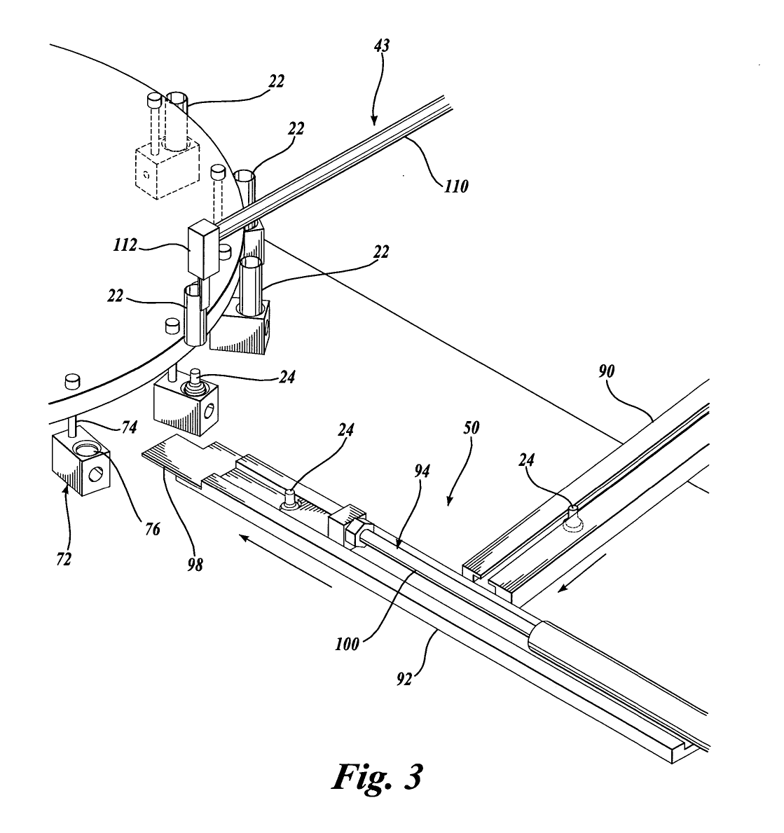

A material handling system 40 for automatically assembling and transporting seed blanks 20 between a plurality of assembly stations is best seen by referring to FIGS. 2 and 3. The material handling system 40 includes a transport assembly 42, a heater 44, a cooling assembly 46, a media filler assembly 48, and a restraint handling assembly 50.

The transport assembly 42 includes a carousel 60 operatively connected to a drive assembly 62 by a spindle shaft 64 extending through a platform 66. The drive assembly 62 is suitably a well-known motor, such as a stepper motor or a well known AC or DC motor. The spindle shaft 64 is suitably a rod extending between the drive assembly 62 and a disc-shaped holder plate 68. The spindle shaft 64 is coupled to the holder plate 68 by a well known bearing 70.

Disposed around the perimeter of the holder plate 68 is a plurality of receptacles 72, commonly referred to as “pucks.” The receptacles 72 suitably hang from the holder plate 68 by a pin 74. Each receptacle 72 also includes a seat 76 sized to receive a cotyledon restraint 24. As coupled to the holding plate 68, the receptacles 72 are disposed in a substantially circular configuration. Although a substantially circular configuration of receptacles is preferred, other sequential configurations, such as an oval or substantially linear configuration, are also within the scope of the present invention.

As may be best seen by referring to FIG. 3, the restraint handling assembly 50 will now be described in greater detail. The restraint handling system 50 includes a feeder arm 90, a guide arm 92, and a pusher assembly 94. The feeder arm 90 is suitably coupled to a reservoir (not shown) containing a plurality of cotyledon restraints 24. The cotyledon restraints 24 are stored within the reservoir and are fed onto the feeder arm 90, such that the stem 96 of the cotyledon restraint 24 is positioned upwards. The cotyledon restraint 24 slides down the feeder arm 90 where it intersects and slides onto the guide arm 92.

The guide arm 92 includes a bridge 98 extending from one end of the guide arm 92. During operation of the material handling system 40, receptacles 72 are selectively displaced into a position adjacent the free end of the bridge 98, as is described in greater detail below.

The pusher assembly 94 is suitably a hydraulically operated mechanism that includes a push rod 100 positioned to selectively slide the cotyledon restraint 24 along a track 102 of the guide arm 92 and onto the bridge 98 when a receptacle 72 is located adjacent the free end of the bridge 98. The pusher assembly 94 slides the cotyledon restraint 24 off of the bridge 98 and into the seat 76 of the receptacle 72. After the cotyledon restraint 24 is disposed on the receptacle 72, the drive assembly 62 conditionally actuates the transport assembly 42 to a second assembly station, where a seed shell 22 is coupled to the cotyledon restraint 24 by the seed shell handling assembly 43.

The seed shell handling assembly 43 includes an arm 110 having a tweezer assembly 112 operatively connected to one end of the arm 110. The tweezer assembly 112 is suitably a controllable pickup device adapted to selectively retrieve seed shells 22 from a reservoir (not shown). The seed shell handling assembly 43 positions a seed shell 22 above the stem 96 of the cotyledon restraint 24. As positioned, the arm 110 selectively displaces the seed shell 22 downwardly, such that the cotyledon restraint 24 is received within the seed shell 22. The tweezer assembly 112 then releases the seed shell 22, and the arm 110 raises upwardly and away from the now-joined cotyledon restraint 24 and seed shell 22.

Although it is preferred that the arm 110 actuates downwardly to place the seed shell 22 into contact with a cotyledon restraint 24, it should be apparent that other methods, such as displacing the transport assembly 42 upwardly to place the cotyledon restraint 24 into contact with the seed shell 22, are also within the scope of the present invention. It should also be apparent that although a material handling system 40 having both a restraint handling assembly 50 and a seed shell handling assembly 43 is preferred, they are optional to the operation of such a system. As a nonlimiting example, a seed shell and cotyledon restraint may be preassembled at a location separate from the material handling system 40, such that a seed shell already including a cotyledon restraint disposed therein may be placed onto the receptacle either by hand, the seed shell handling assembly 43, or an equivalent apparatus. Accordingly, such embodiments are also within the scope of the present invention.

Referring back to FIG. 2, the media filler assembly 48 will now be described in greater detail. The media filler assembly 48 includes a filler arm 120 and a dispensing nozzle 122 in fluid communication with the filler arm 120. The filler arm 120 is operatively connected to a reservoir (not shown) containing liquid gametophyte. The dispensing nozzle 122 is suitably located above a bore 170 extending through a portion of the cooling assembly 46. Although the present embodiment describes the dispensing nozzle 122 as located proximate to a bore extending through the cooling assembly, other embodiments, such as locating the dispensing nozzle before the cooling assembly, are also within the scope of the present invention.

When a seed shell 22 is located beneath the dispensing nozzle 122, the media filler assembly 48 selectively dispenses a predetermined amount of gametophyte 26 into the open end of the seed shell 22. The exact amount of gametophyte dispensed into the seed shell 22 varies according to the volume of the seed shell 22. In one preferred embodiment, the seed shell 22, including the cotyledon restraint 24, is filled with gametophyte 26 to a predetermined volume that is less than the total available volume after the cotyledon restraint 24 is disposed within the seed shell 22. As a non-limiting example, the predetermined volume of gametophyte 26 disposed within the seed shell 22 is about 10 to 50 mm³ less than the total available volume of the seed shell 22 containing the cotyledon restraint 24. The exact volume is determined to permit attachment of the dead end seal (not shown) to the resulting seed blank 20. Accordingly, the predetermined amount of gametophyte is a direct function of the size and shape of a seed shell 22 and, in certain embodiments, is less than the total volume available. After the predetermined amount of gametophyte is dispensed into the seed shell 22 at this assembly station, the material handling system 40 selectively transports the seed shell 22 to the cooling assembly 46.

The cooling assembly 46 is a well known chiller and only portions are shown for ease of description. The cooling assembly 46 includes a chiller box 130 substantially encasing a plurality of receptacles 72 to accelerate a state change of gametophyte 26 within the seed shells 22. Specifically, the cooling assembly 46 accelerates the rate by which the gametophyte 26 changes state from a substantially liquid state to a gelatin-like state. Also, the cooling assembly 46 may assist in bonding the cotyledon restraint 24 within the seed shell 22 for those embodiments where the cotyledon restraint 24 and seed shell 22 are coupled together as part of the seed blank 20 manufacturing process. Specifically, before the gametophyte 26 is deposited within the seed shell 22, the seed shell 22 is passed through a portion of the cooling assembly 46, thereby accelerating the rate at which the seed shell 22 and cotyledon restraint 24 are bonded. Although it is preferred that the cooling assembly 46 pre-cool the combination seed shell and cotyledon restraint, other embodiments, such as permitting the seed shell and cotyledon restraint bond under ambient conditions, are also within the scope of the present invention. After completion of the cooling stage, the combination of the seed shell 22, cotyledon restraint 24, and gametophyte 26 is commonly referred to as a “seed blank.”

Although a plurality of receptacles 72 are illustrated as being disposed within the cooling assembly 46, other embodiments, such as only one receptacle 72 within the chiller box 130, are also within the scope of the present invention. Also, the cooling assembly 46 is an optional component of the material handling system 40 and, therefore, other embodiments, such as material handling systems that do not include a cooling assembly, are also within the scope of the present invention.

After the cooling cycle has been completed, the drive assembly 62 selectively actuates the transport assembly 42 to a discharge station 140. At the discharge station 140, the seed blank 20 is removed from the receptacle 72 and into a holding bin 142 by a pneumatically or hydraulically actuated arm 144. Specifically, the arm 144 moves in a direction indicated by the arrow 146, thereby knocking the seed blank 20 off of the receptacle 72 and into the holding bin 142. Thereafter, the seed blanks are transported to another location where an embryo is inserted within the cotyledon restraint 24 and an end seal (not shown) is applied to the open end of the seed blanks 20 to seal the embryo within the seed blank 20.

Still referring to FIG. 2, the heater 44 will now be described in greater detail. In that regard, a collar 150 housing heating coil or a warm air blower assembly (not shown) substantially encases a plurality of receptacles 72. As housed within the collar 150, heat is either radiated or blown onto the receptacles 72 to raise the temperature of each receptacle 72, such that when the seed shell 22 is placed onto a cotyledon restraint 24 by the seed shell handling assembly 43, heat from the receptacle 72 melts and bonds the cotyledon restraint 24 within the seed shell 22. Although a plurality of receptacles 72 are illustrated as being disposed within the collar 150, it should be apparent that other embodiments, such as a collar housing only a single receptacle, are also within the scope of the present invention. Also, it should be apparent that a heater is an option to the material handling system 40 of the present invention and, therefore, other embodiments, such as a material handling system without a heater, are also within the scope of the present invention.

A summary of the method of the present embodiment is best understood by referring to FIG. 2. In that regard, at least one receptacle 72 is preheated by the heater 44 to a desired temperature. After the desired temperature is achieved, the drive assembly 62 selectively rotates the transport assembly 42 in a direction indicated by the arrow 152, into another assembly station to receive a cotyledon restraint 24 from the restraint handling assembly 50.

At this assembly station, the cotyledon restraint 24 is selectively displaced onto the seat 76 by the push rod 100. Thereafter, the receptacle 72 containing the cotyledon restraint 24 is transported to another assembly station where the seed shell 22 is placed onto the cotyledon restraint 24 by the seed shell handling assembly 43, as described above.

After the seed shell 22 is placed onto the cotyledon restraint 24, the transport assembly 42 is again actuated to yet another assembly station, where gametophyte 26 is displaced into the open end of the seed shell 22 by the media filler assembly 48. Once again, the drive assembly 62 actuates the transport assembly 42 to move the receptacle 72 into the cooling assembly 46, where the state change of the gametophyte 26 disposed within the seed shell 22 is accelerated by the reduced temperature within the chiller box 130.

The transport assembly 42 continues to rotate about the spindle shaft 64, thereby rotating the receptacle 72 into the discharge station 140, where the seed blank 20 is deposited into the holding bin 142 by the arm 144. Although the method and system of the present invention has only been described with respect to a single seed shell 22 being disposed on a single receptacle 72, it should be apparent that other embodiments are also within the scope of the present invention. As a nonlimiting example, as the receptacle 72 is transported being various assembly stations, multiple seed blanks may be in various stages of assembly. Thus, multiple seed shells may be simultaneously assembled utilizing the material handling system and method of the present invention.

From the foregoing description, it can be seen that the method and system of manufacturing artificial seed coats formed in accordance with the embodiments of the present invention incorporate many novel features and offers significant advantages over currently available systems. While the presently preferred embodiments of the invention have been illustrated and described, it is to be understood that, within the scope of the appended claims, various changes can be made therein without departing from the spirit of the invention.

As a nonlimiting example, various assembly stations may be combined at a single location. Specifically, the seed shell handling assembly and media filler assembly may be accomplished at a single location. In that regard, after the seed shell handling assembly 43 displaces a seed shell 22 onto a cotyledon restraint 24, the media filler assembly 48 may be displaced into proximity to the open end of the seed shell 22 to dispense media into the seed shell 22 at the same location where the seed shell handling assembly 43 placed the seed shell 22 onto the cotyledon restraint 24. Accordingly, such embodiments are also within the scope of the present invention.

1. In a material handling system having means for automatically assembling and transporting an artificial seed blank between a plurality of assembly stations arranged in a sequential configuration, wherein the means for automatically assembling and transporting an artificial seed blank between the plurality of assembly stations includes a plurality of receptacles, a method of manufacturing an artificial seed blank, comprising:
(a) placing a seed shell on one of the plurality of receptacles at a first assembly station;
(b) depositing media into the seed shell;
(c) positioning the seed shell at a second assembly station; and
(d) removing the seed shell from the receptacle at the second assembly station.

2. The method of manufacturing an artificial seed blank of claim 1, further comprising heating a predetermined number of the plurality of receptacles to bond the seed shell to a restraint disposed within the seed shell.

3. The method of manufacturing an artificial seed blank of claim 2, further comprising cooling the seed shell after depositing media into the seed shell.

4. The method of manufacturing an artificial seed blank of claim 1, further comprising placing a restraint on one of the plurality of receptacles before placing a seed shell on one of the plurality of receptacles at a first assembly station.

5. The method of manufacturing an artificial seed blank of claim 4, further comprising heating at least one of the plurality of receptacles to bond the seed shell to the restraint.

6. The method of manufacturing an artificial seed blank of claim 5, further comprising cooling the seed shell after depositing media into the seed shell.

7. The method of manufacturing an artificial seed blank of claim 1, wherein the plurality of receptacles are arranged in a substantially circular pattern.

8. The method of manufacturing an artificial seed blank of claim 7, wherein the means for automatically assembling and transporting an artificial seed blank between the plurality of assembly stations includes a carousel and the plurality of receptacles are coupled to the carousel.

9. The method of manufacturing an artificial seed blank of claim 7, further comprising heating at least one of the plurality of receptacles before placing a seed shell on one of the plurality of receptacles.

10. The method of manufacturing an artificial seed blank of claim 9, further comprising depositing a restraint on one of the plurality of receptacles before placing a seed shell on one of the plurality of receptacles.

11. The method of manufacturing an artificial seed blank of claim 10, further comprising positioning the seed shell at a cooling station before depositing media into the seed shell to accelerate a state change of the media.

12. A material handling system for automatically assembling and transporting an artificial seed blank between a plurality of assembly stations arranged in a sequential configuration, the material handling system comprising:
(a) a transport assembly having a plurality of receptacles, each one of the plurality of receptacles sized to receive an artificial seed shell;
(b) a drive assembly coupled to the transport assembly to selectively transport at least one of the plurality of receptacles between the plurality of assembly stations; and
(c) a cooling assembly in communication with a portion of the transport assembly to accelerate a change in state of media disposed within the seed shell.

13. The material handling system of claim 12, further comprising a heater in communication with at least one of the plurality of receptacles, wherein the heater is adapted to preheat the at least one of the plurality of receptacles.

14. The material handling system of claim 13, further comprising a seed shell handling assembly, the seed shell handling assembly is adapted to place a seed shell on one of the plurality of receptacles.

15. The material handling system of claim 14, further comprising a restraint handling assembly, the restraint handling assembly is adapted to place a restraint on at least one of the plurality of receptacles before the seed shell handling assembly places a seed shell on one of the plurality of receptacles.

16. The material handling system of claim 15, wherein when the restraint and seed shell are placed on at least one of the plurality of receptacles, the restraint and seed shell are bonded together by heat radiating from the receptacle.

17. The material handling system of claim 14, further comprising a media filler assembly positioned to selectively deposit a predetermined volume of media into a seed shell at least one of the plurality of assembly stations.

18. The materials handling system of claim 17, wherein the drive assembly includes a stepper motor to selectively actuate the transport assembly between the plurality of assembly stations.

19. A material handling system for automatically assembling and transporting an artificial seed blank between a plurality of assembly stations arranged in a sequential configuration, the material handling system comprising:
(a) means for transporting an artificial seed shell between a plurality of assembly stations;
(b) means for placing the artificial seed shell on the means for transporting an artificial seed shell between the plurality of assembly stations;
(c) means for depositing a media within the artificial seed shell; and
(d) means for cooling, the means for cooling in communication with the means for transporting an artificial seed shell between a plurality of assembly stations to accelerate a change of state of media deposited within the seed shell.

20. The material handling system of claim 19, further comprising means for pre-heating in communication with the means for transporting an artificial seed shell between the plurality of assembly stations, the means for heating adapted to pre-heat a portion of the means for transporting an artificial seed shell between the plurality of assembly stations.
